(19) United States
(12) Patent Application Publication
(10) Pub. No.: US 2019/0378079 A1
(43) Pub. Date: Dec. 12, 2019

(54) DETERMINING USER PRIORITIES BASED ON ELECTRONIC ACTIVITY

(71) Applicant: Microsoft Technology Licensing, LLC, Redmond, WA (US)

(72) Inventors: Shahil Soni, Seattle, WA (US); Michael Kumar, Seattle, WA (US)

(21) Appl. No.: 16/001,590

(22) Filed: Jun. 6, 2018

(51) Int. Cl. G06Q 10/06; G06Q 10/10

(52) U.S. Cl. CPC G06Q 10/063114; G06Q 10/06314; G06Q 10/107

(57) ABSTRACT

Methods and systems for automatically determining a priority of a user or a group of users based on electronic activity of the user or group of users. One system includes an electronic processor configured to determine a topic of each of a plurality of electronic communications associated with the user and determine a plurality of communication groups, wherein each communication group includes a subset of the plurality of electronic communications having a common topic. The electronic processor is also configured to rank the plurality of communication groups and perform at least one automatic action for at least one of the plurality of communication groups based on the plurality of communication groups as ranked.

### FIELD

Embodiments described herein generally relate to methods and systems for determining user priorities based on electronic activity, such as, for example, electronic communications sent and received by a user.

### SUMMARY

A user, while at work, uses a variety of electronic communication tools to communicate and collaborate with colleagues. These tools include electronic mail (“e-mail”) applications, text messaging applications, chat applications, calendar applications, and the like. When working with these tools, the user may discuss work projects using electronic communications. These electronic communications can indicate progress made on a project, meetings scheduled for a project, what project a user is working on, how long a user has been working on a project, and other indications of, generally, what the user is currently working on.

As many users work on multiple projects simultaneously, it can be difficult to track what projects the user is currently handling, especially as the number of projects increases, the number of electronic communications increases, the number of tools used by the user increases, or a combination thereof. Accordingly, it can be difficult for individual users to track their projects and associated priorities and it can be equally difficult for an organization to track its workers' project and associated priorities to make sure that resources are used appropriately.

Thus, as described in more detail below, embodiments described herein may automatically track a user's priorities and work habits, such as by monitoring a user's e-mail inbox. The tracked information can be used in performance evaluation or as general work tracking. For example, embodiments described herein provide a streamlined process for tracking, recording, and ranking user priorities so that the user can not only see what projects they are handling but also how much effort they are putting into each project, which allows the user to better prioritize what needs to be done and plan how to get it done.

One embodiment provides a system for automatically determining a priority of a user based on electronic activity of the user. The system includes an electronic processor configured to determine a topic of each of a plurality of electronic communications associated with the user and determine a plurality of communication groups, wherein each communication group includes a subset of the plurality of electronic communications having a common topic. The electronic processor is also configured to rank the plurality of communication groups and perform at least one automatic action for at least one of the plurality of communication groups based on the plurality of communication groups as ranked.

Another embodiment provides a method of automatically determining a priority of a user based on electronic activity of the user. The method includes determining, with an electronic processor, a topic of each of a plurality of electronic communications associated with the user and determining, with the electronic processor, a plurality of communication groups, wherein each communication group includes a subset of the plurality of electronic communications having a common topic. The method also includes, determining, with the electronic processor, for each of the plurality of communication groups, a priority score of the common topic associated with the communication group for the user and ranking, with the electronic processor, the plurality of communication groups based on the priority score of each of the plurality of communication groups. In addition, the method includes performing at least one automatic action for at least one of the plurality of communication groups based on the priority score of each of the plurality of communication groups as ranked.

A further embodiment includes a non-transitory, computer-readable medium comprising instructions that, when executed by an electronic processor, perform a set of functions. The set of functions includes determining a topic of each of a plurality of electronic communications associated with a group of users, determining a plurality of communication groups, wherein each communication group includes a subset of the plurality of electronic communications having a common topic, and determining, for each of the plurality of communication groups, a priority score of the common topic associated with the communication group for the group of users. The set of functions also includes ranking the plurality of communication groups based on the priority score of each of the plurality of communication groups and performing at least one automatic action for at least one of the plurality of communication groups based on the priority score of each of the plurality of communication groups as ranked.

### BRIEF DESCRIPTION OF THE DRAWINGS

FIG. 1 schematically illustrates a system for determining user priorities according to one embodiment.

FIG. 2 schematically illustrates a user device included in the system of FIG. 1 according to one embodiment.

FIG. 3 illustrates a method of determining user priorities performed by the system of FIG. 1 according to one embodiment.

FIG. 4 illustrates a user interface for displaying user priorities according to one embodiment.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory, computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

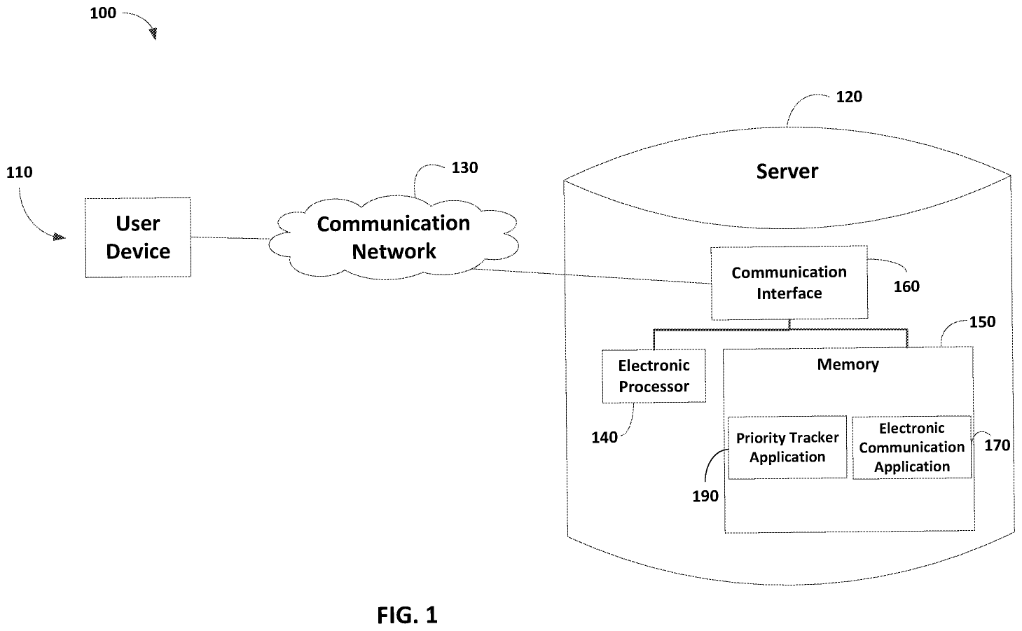

FIG. 1 schematically illustrates a system 100 for determining user priorities. The system 100 includes at least one user device 110 (individually referred to herein as a “user device 110” or collectively referred to herein as “user devices 110”) and a server 120. The user device 110 communicates with the server 120 via a communication network 130. It should be understood that the system 100 may include additional components than those illustrated in FIG. 1 in various configurations. For example, although only one user device 110 is illustrated in FIG. 1 as one example configuration of the system 100, many more devices may interact with the server 120. Furthermore, the server 120 may include any number of servers organized in various configurations including a set of servers providing cloud-based services. Also, a user device 110 may communicate with the server 120 over additional communication networks 130 or a network different from the communication network 130 used by a different user device 110. In addition, in some embodiments, a user device 110 communicates with the server 120 over the communication network 130 via one or more intermediary devices, including, for example, firewalls, gateways, routers, and the like.

The communication network 130 illustrated in FIG. 1 can include wired networks, wireless networks, or a combination thereof that enable communications between the various entities in the system 100. In some configurations, the communication network 130 includes cable networks, the Internet, local area networks (LANs), wide area networks (WAN), mobile telephone networks (MTNs), and other types of networks, possibly used in conjunction with one another, to facilitate communication between the user device 110 and the server 120.

As illustrated in FIG. 1, the server 120 includes an electronic processor 140, a memory 150, and a communication interface 160. The electronic processor 140, the memory 150, and the communication interface 160 communicate wirelessly, over one or more wired communication channels or busses, or a combination thereof. The memory 150 includes non-transitory, computer-readable medium, such as random access memory, read-only memory, or a combination thereof. The electronic processor 140 can include a microprocessor configured to execute instructions stored in the memory 150. The memory 150 can also store data used with and generated by execution of the instructions. The communication interface 160 allows the server 120 to communicate with external networks and devices, including the communication network 130. For example, the communication interface 160 may include a wireless transceiver for communicating with the communication network 130. It should be understood that the server 120 may include additional components than those listed in FIG. 1 in various configurations. For example, in some embodiments, the server 120 includes a plurality of electronic processors, a plurality of memories, a plurality of communication interfaces, or a combination thereof. As also noted above, the functionality described herein as being performed by the server 120 may be distributed over multiple servers, such as servers operated within a cloud environment. Furthermore, in some embodiments, functionality described herein as being performed by the server 120 may be performed locally at the user device 110.

The server 120 provides a variety of services to the user device 110. One of these services includes an electronic communication service. For example, as illustrated in FIG. 1, the memory 150 included in the server 120 stores an electronic communication application 170. The electronic communication application 170 (as executed by the electronic processor 140) allows a user (via the user device 110) to send and receive (access and view) electronic communications. As used in the present application, “electronic communications” include e-mail messages, text messages, instant messages, chat messages, calendar events, or other types of messages or data communicated electronically. For example, in some embodiments, the electronic communication application 170 includes Exchange® provided by Microsoft Corporation, which allows users to send and receive e-mail messages. The electronic communication application 170 may also include a calendar feature that allows the user to schedule meetings with other users, a task feature that allows the user to create a to-do list or otherwise manage tasks, a contact feature for storing contact information, a document or file management feature for managing stored files, or a combination thereof. Also, in some embodiments, the server 120 may execute separate applications (stored in the memory 150) to provide these additional services.

The server 120 also includes a priority tracker application 190 stored in the memory 150. As described in more detail below, the priority tracker application 190, when executed by the electronic processor 140, is configured to analyze electronic communications managed via the electronic communication application 170 to determine priorities for a user. It should be understood that, in some embodiments, the priority tracker application 190 is included in the electronic communication application 170. Also, in some embodiments, the priority tracker application 190 (or a portion thereof) may be stored locally on the user device 110.

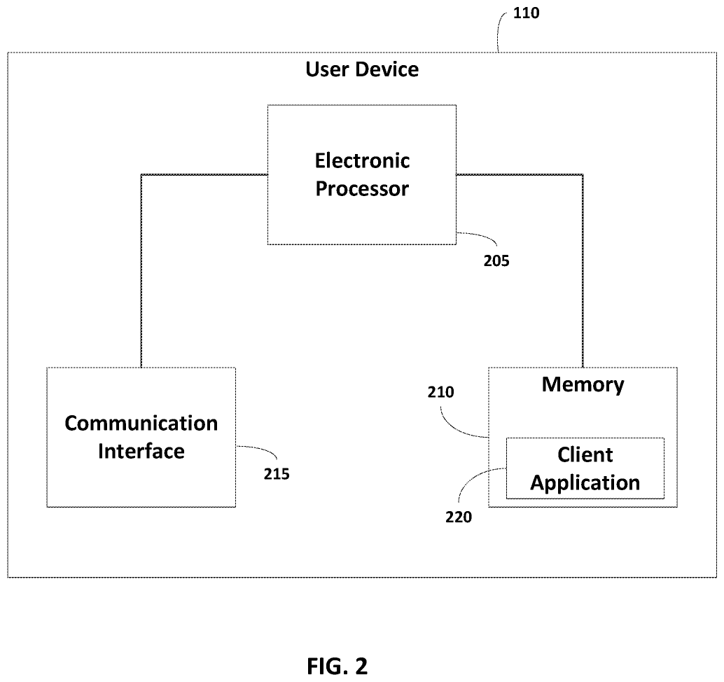

The user device 110 accesses the server 120 (via the communication network 130) to use one or more of the services provided by the server 120. The user device 110 may be implemented as any number of computing devices, including, without limitation, a personal computer, a laptop computer, a desktop computer, a portable digital assistant (PDA), a mobile phone, tablet computer, an electronic book (eBook) reader device, a set-top box, a game console, a smart television, a wearable device (for example, a smart watch, electronic “smart” glasses, a fitness tracker, or the like), or any other electronic device that can transmit and receive data over one or more networks. As illustrated in FIG. 2, the user device 110 may include an electronic processor 205, a computer-readable memory 210, and a communication interface 215 similar to the electronic processor 140, the memory 150, and the communication interface 160 as described above with respect to the server 120. As illustrated in FIG. 2, the memory 210 included in the user device 110 stores a client application 220. The client application 220, as executed by the electronic processor 205, allows a user to access the services provided by the server 120. In some configurations, the client application 220 includes a dedicated application for communicating with the server 120 and accessing the services, such as, for example, Outlook® provided by Microsoft Corporation. Alternatively, the client application 220 may include a web browser (for example, Internet Explorer® provided by Microsoft Corporation) that allows the user device 110 to access the services provided by the server 120. It should be understood that the user device 110 may include additional components in various configurations than as illustrated in FIG. 2. For example, the user device 110 may include one or more human machine interfaces, such as a display device (a touchscreen), a cursor-controlled device, a keyboard, a speaker, a microphone, or the like.

As described above, it is often difficult for a user to track what projects he or she is working on. Accordingly, the priority tracker application 190 may be configured to automatically determine priorities of a user by analyzing the user's use of the services through the server 120. In particular, the priority tracker application 190 may be configured to automatically process e-mail messages sent and received by a user to determine topics of conversation, which can be scored and ranked to provide a user with a report of how they spent their time and what projects are priorities for the user. The priority tracker application 190 may use machine learning to track what the user is working on in a given timeframe and determine what project the user has been focusing on. The priority tracker application 190 may be configured to calculate various scores based on a type of communication and a number of communications associated with a particular topic of conversation.

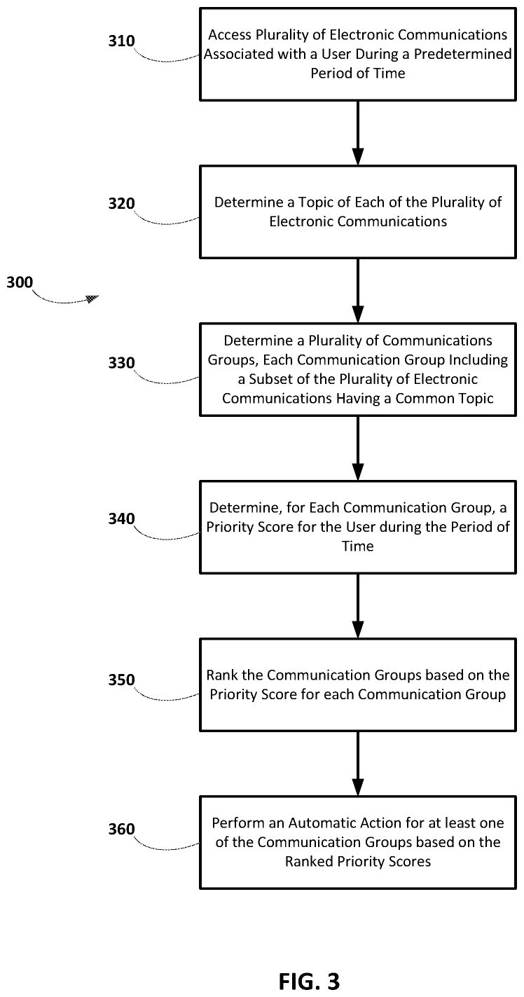

For example, FIG. 3 illustrates a method 300 of determining user priorities performed by the priority tracker application 190 (as executed by the electronic processor 140) according to one embodiment. Again, as noted above, the methods described herein as being performed by the priority tracker application 190 (or portions thereof) may be performed or distributed among multiple applications, such as, for example, the electronic communication application 170.

As illustrated in FIG. 3, the method 300 includes accessing a plurality of electronic communications, such as electronic communications exchanged via the electronic communication application 170 (at block 310). The electronic communications may be associated with a single user or a group of users. Also, in some embodiments, the electronic communications are associated with a predetermined period of time, such as, for example, a previous month, the past six months, or the like. In some embodiments, the predetermined period of time is configurable by a user (for example, via a user interface provided via the priority tracker application 190) to customize a priority report as desired. The electronic communications may include e-mail messages, text messages, chat messages, calendar events or invites, voice mail messages, notes, or the like. Again, in some embodiments, the type of electronic communications accessed by the priority tracker application 190 is configurable by a user.

The method 300 also includes automatically determining a topic of each of the plurality of electronic communications (at block 320). The topic of an electronic communication describes the subject matter of the electronic communication. For example, the topic of an e-mail message may be “Deployment of new accounting software,” “Project XYZ,” or “quarterly review.”

In some embodiments, the priority tracker application 190 parses content (such as text) included in each of the electronic communications using natural language processing (“NLP”) software to determine a topic for the electronic communication. With regard to e-mail messages, the priority tracker application 190 may use a subject line of the message (or a portion thereof) as the topic. Also, in some embodiments, the priority tracker application 190 may identify nouns, noun phrases, codes, or the like within the content of an electronic communication to determine the topic. In some embodiments, the priority tracker application 190 may transmit content included in an electronic communication to a separate parsing application (provided via the server 120 or remote from the server 120), which may return a topic for the content. It should be understood that the priority tracker application 190 may also or alternatively use metadata associated with an electronic communication, such as, for example, timing information for an electronic communication, sender or recipient information for an electronic communication, attendee information for a calendar event, or the like, to determine the topic of an electronic communication. It should also be understood that the priority tracker application 190 may be configured to determine a topic of an electronic communication as communications are received in addition or as an alternative to determining topics for a batch of communications as described above.

In some embodiments, a user sets rules that determine how topics are determined. For example, for calendar event, a user may specify that the topic of a meeting includes the description of the calendar event and a combined list of invitees to the calendar event (if any). The priority tracker application 190 may provide a user interface that allows the user to set these rules. Alternatively or in addition, the priority tracker application 190 may perform machine to automatically determine frequent or common topics and identify the same or similar topics in electronic communications.

As illustrated in FIG. 3, the method 300 also includes determining a plurality of communication groups based on the determined topics for the electronic communications (at block 330). Each determined communication group includes a subset of the plurality of electronic communications having a common topic. As used in this application, a “common topic” includes an identical topic (for example, two electronic communications having the topic “meeting about telemetry”), a similar topic (for example, two electronic communications, one having the topic “Outlook” and one having the topic “e-mail”), or a related topic (for example, two electronic communications, one having the topic “questions regarding existing telemetry” and one having the topic “new telemetry guidelines”). Identical topics, similar topics, and related topics may be defined by the user or may automatically be learned using machine learning techniques. For example, a common topic may be identified between two topics based on a number of identical words or phrases included the topics. Alternatively or in addition, the priority tracker application 190 may maintain tables or definitions of related words or phrases, which can be used to translate and match topics. For example, if the topic of one electronic communication is “Outlook” and the topic of another electronic communication is “e-mail,” the priority tracker application 190 may be configured to identify these topics as having a common topic of “e-mail services” although the original topics to do not have identical terms or phrases.

In some embodiments, each of the plurality of electronic communications is included in one of the communication groups. In a situation where an electronic communication is included in more than one communication group, the priority tracker application 190 may be configured to select one of the groups for the electronic communication. The priority tracker application 190 may apply various rules to select a single communication group for a particular electronic communication. Again, these rules may be configured manually or automatically using machine learning.

The method 300 further includes determining a priority score for each of the plurality of communication groups (at block 340). The priority score of each of the plurality of communication groups indicates the amount of time, an effort, an importance, or a combination thereof for the common topic associated with each communication group. The priority score of each of the plurality of communication groups may be based on a number of factors, such as, for example, a quantity of electronic communications included in the subset of the communication group. For example, the priority score of a communication group including fifty electronic communications may be “50,” which may indicate that a user spent more time on the topic associated with this group than the topic of another communication group that has a score of “30.” These types of priority scores may be used to track how much time a user has spent on a particular topic (project).

Alternatively or in addition, the priority score may be based on the type of electronic communications included in each communication group. For example, electronic communications can be assigned different weights, which impact the overall priority score for the group. For example, accepted calendar invites may have a greater weight than an e-mail message for a common topic. Thus, for a communication group including two e-mail messages and one accepted calendar invite, wherein e-mail messages have a weight of 1 and accepted calendar invites have a weight of 5, the priority score for the communication group may be seven (two e-mail messages times a weight of 1 plus one accepted calendar invite times a weight of 5). These types of priority scores may be used to track how much effort a user has expended on a topic and, thus, the priority or importance of the topic to the user. The type of electronic communication may be set based on the particular application or feature managing the communication (for example, e-mail message, calendar event, text message, or the like). Alternatively or in addition, the type of electronic communication may be set based on a parameter of the communication, such as, for example, whether the calendar event was received as an invite and accepted, whether the user originated the e-mail message or replied to the e-mail message, or the like. Similarly, weights may be assigned to electronic communications based on other parameters, such as how many users were included on a particular electronic communication, how quickly a user responded to a particular electronic communication, how many replies were received for a particular electronic communication, whether a particular electronic communication was marked or categorized as “urgent” or “important,” or the like. Weights set on these types of parameters may be set by applying one or more rules to weights defined for different types of electronic communications. For example, if a user flagged an e-mail message as “urgent” or requiring follow-up, the weight generally assigned to e-mail messages may be multiplied by a predetermined factor to adjust the weight based on the flag.

The weights and rules assigned to electronic communications may be set manually (via a user interface), automatically (via machine learning), or a combination thereof. For example, machine learning techniques can be used to automatically learn what words, phrases, colleagues, meeting times or locations, or other content or metadata associated with an electronic message designate an urgent or important project for a particular user. For example, if a user sends and receives a large amount of e-mail messages and does not attend a large amount of meetings, the priority tracker application 190 may use machine learning to automatically learn these tendencies of the user and may assign weights (and associated rules) accordingly, such as by weighting meetings more than e-mail messages. Accordingly, the weights and associated rules may be developed for individual users. However, in other embodiments, the weights and rules may be set for a group of users.

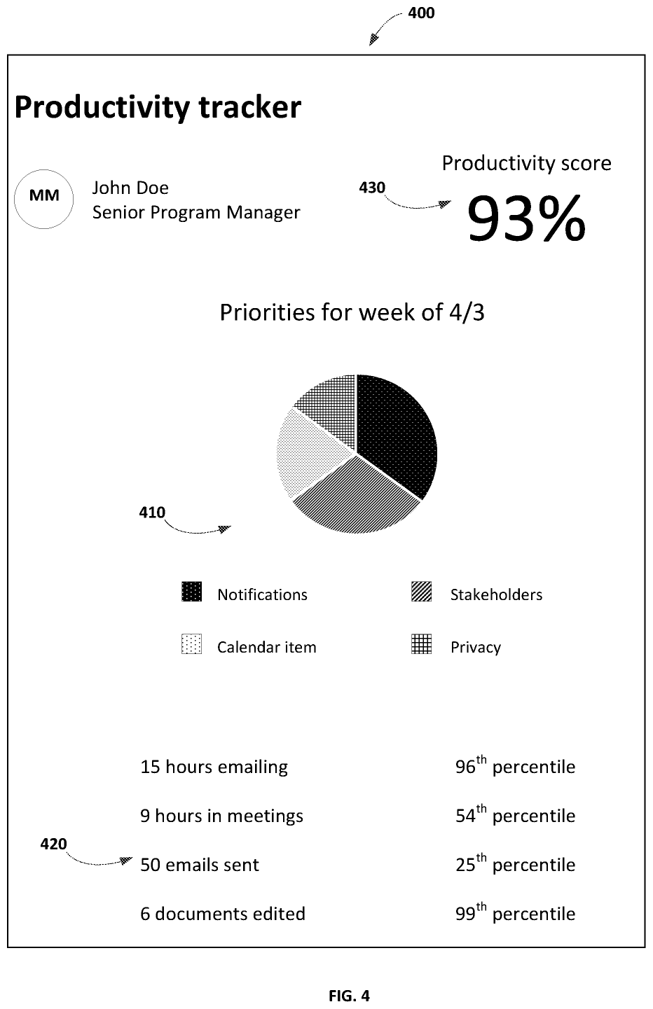

The method 300 also includes ranking the plurality of communication groups based on the determined priority scores (at block 350) and performing at least one action based on the ranked priority scores (at block 360). For example, the communication groups may be ranked from highest score to lowest score and the user may be notified of one or more of the highest scores. In some embodiments, the priority tracker application 190 may notify users of scores using one or more user interface, which may be presented within user interfaces provided via the electronic communication application 170. For example, FIG. 4 illustrates a user interface 400 for displaying user priorities according to one embodiment. As illustrated in FIG. 4, the user interface 400 may include a graphical representation 410 of a user's priorities, such as a graph or chart. In some embodiments, the graphical representation 410 may be replaced with a numerical list (for example, “1: Notifications, 2: Stakeholders, 3: Calendar item, 4: Privacy”). The graphical representation 410 may include all topics, a top predetermined number of priorities (for example, the five topics with the highest priority scores), all topics with priority scores over a predetermined threshold, or the like. In some embodiments, the user interface 400 includes multiple scores or rankings for one or more topics. For example, priority scores can be provided designating what topics the user has spent the most time one and separate priority scores can be provided designating what topics are the most urgent or important to the user.

As illustrated in FIG. 4, the user interface 400 also includes one or more statistics 420 for a particular communication group or all communication groups. In some embodiments, the statistics 420 include a time period spent performing an action (such as fifteen hours e-mailing or nine hours attending meetings), an quantity of electronic communications (such as fifty e-mail messages were sent or received), a number of files accessed or edited (such as six files were edited), and the like. In some embodiments, the statistics 420 can be combined in various configurations, such as across all communication groups (topics) or a set of user-selected groups (topics). When these statistics 420 are determined for other users (or other groups of users), a particular user's statistics 420 may be compared or ranked, such as by providing a percentile ranking of each statistic 420.

The priority tracker application 190 may also determine a productivity score 430 for a user (or group of users). In some embodiments, the productivity score 430 may be determined by calculating a percentage of electronic communications grouped into the top priorities (for example, the topics represented in the graphical representation). For example, if 57% of a user's electronic communications were associated with one of the top five priorities, the user's productivity score 430 may be set to 57%.

In some embodiments, a user can select data included in the user interface 400 to access additional data. For example, a user can select a particular topic from the graphical representation 410 to view the electronic communications grouped in this topic. In some embodiments, a user can modify the topic assigned to a particular electronic communication, which may cause the priority tracker application 190 to re-calculate priority scores and rankings. This feedback may also be used as part of the machine learning logic to improve the performance of the priority tracker application 190. Similarly, in some embodiments, a user may be able to provide feedback via the user interface 400 regarding the priority rankings of the displayed topics, which may be used to automatically update the logic performed by the priority tracker application 190.

In addition to or as an alternative to notifying a user of priorities, the priority tracker application 190 may be configured to automatically prioritize electronic communications as accessed by a user via the electronic communication application 170. For example, electronic communications grouped into a top with the highest (or one of the highest) priority score may be flagged or otherwise marked when displayed within the electronic communication application 170. Similarly, in other embodiments, these electronic communications may be moved to a top of a user's inbox or calendar, moved to a separate list or queue, or the like. Also, in some embodiments, based or regardless of the priority score assigned to a particular topic, electronic communications may also be automatically grouped or pinned based on assigned communication group. All of these actions allow a user to easily access electronic communications associated with the communication group with a high priority score. It should be understood that the marking and flagged described herein can be applied to those electronic communications previously grouped as relating to a particular topic as well as subsequent electronic communications. For example, if the priority tracker application 190 determines that topic “accounting software deployment” was the user's top priority for the past month, new electronic communications (e-mail messages, calendar events, and the like) received in the next month also associated with this topic may be flagged or marked as described above. Thus, in addition to provide users with a dashboard or snapshot of priorities based on historical activity, the priority tracker application 190 may be configured to process electronic communications as they are received to determine whether a newly-received electronic communications relates to one or more predetermined topics.

It should be understood that the priority tracker application 190, as described herein, may be used by a user to access the user's own priorities or other user's priorities. For example, a manager may use the priority tracker application 190 to view priorities of a user managed by the manager. Also, as noted above, the priority tracker application 190 may be configured to determine priorities of a single user or a group. Accordingly, a manager may be able to generate priorities for a department or group within an organization or even the entire organization. For example, at each level within an organization's hierarchy, the priority tracker application 190 may be configured to provide priorities for one or more lower levels. This information may help managers or other leaders track whether priorities of the organization's workforce match a mandate or goal set by the organization. Furthermore, the automatic action performed by the priority tracker application can include generating a notification when at least one of the priority scores fails to satisfy a threshold. For example, if a particular user or group of users hasn't made a particular project their most important project, the notification may alert a manager that adjustments may need to be made. It should also be understood that the priority tracker application 190 may also be used in non-workplace settings, such as family settings, educational settings, and the like.

Thus, embodiments described herein provide methods and systems for automatically tracking electronic activity of a user, such as an e-mail mailbox and calendar, to determine how the user spends his or her time and, optionally, the priority or importance of projects being handled by a user. Tracking this information provides a user with information regarding his or her workload, effectiveness, and productivity, which is useful at performance evaluation times, and also provides managers with insight into workers or groups of workers to ensure that priorities are aligned with the goals of the organization. The priorities may also be used to automatically filter, mark, or otherwise organization electronic communications to focus a user on those communications have the highest priority. The weights and rules applied by the systems and methods to determine such priorities may be configurable by individual users, automatically learned using machine learning techniques, or a combination thereof.

Various features and advantages of some embodiments are set forth in the following claims.

What is claimed is:

1. A system for automatically determining a priority of a user based on electronic activity of the user, the system comprising:
an electronic processor configured to
determine a topic of each of a plurality of electronic communications associated with the user,
determine a plurality of communication groups, wherein each communication group includes a subset of the plurality of electronic communications having a common topic;
rank the plurality of communication groups; and
perform at least one automatic action for at least one of the plurality of communication groups based on the plurality of communication groups as ranked.

2. The system of claim 1, wherein the plurality of electronic communications includes at least one selected from a group consisting of an e-mail message, a text message, an instant message, a chat message, a calendar event, and a voicemail message.

3. The system of claim 1, wherein the electronic processor is configured to determine the topic for at least one of the plurality of electronic communications by parsing content included in the at least one of the plurality of electronic communications.

4. The system of claim 1, wherein the electronic processor is configured to determine the topic for at least one of the plurality of electronic communications based on metadata associated with the at least one of the plurality of electronic communications.

5. The system of claim 1, wherein the electronic processor is further configured to determine, for each of the plurality of communication groups, a priority score of the common topic associated with the communication group for the user, wherein the priority score of the common topic associated with at least one of the plurality of communication groups is based on a quantity of electronic communications included in the at least one of the plurality of communication groups.

6. The system of claim 1, wherein the electronic processor is further configured to determine, for each of the plurality of communication groups, a priority score of the common topic associated with the communication group for the user, wherein the priority score of the common topic associated with at least one of the plurality of communication groups is based on a type of each electronic communication included in the at least one of the plurality of communication groups and a weight assigned to the type.

7. The system of claim 6, wherein the type of each electronic communication included in the at least one of the plurality of communication groups includes at least one selected from an e-mail message and a calendar event.

8. The system of claim 6, wherein the type of each electronic communication included in the at least one of the plurality of communication groups includes at least one selected from an originated e-mail message and a reply e-mail message.

9. The system of claim 1, wherein the electronic processor is further configured to determine, for each of the plurality of communication groups, a priority score of the common topic associated with the communication group for the user, wherein the priority score of the common topic associated with at least one of the plurality of communication groups is based on a weight of at least one electronic communication based on a parameter of the at least one electronic communication.

10. The system of claim 9, wherein the parameter of the at least one electronic communication includes at least one selected from a group consisting of whether the at least one electronic communication was flagged, whether the at least one electronic communication was accepted, how many users are associated with the at least one electronic communication, and how quickly the user responded to the at least one electronic communication.

11. The system of claim 1, wherein the at least one automatic action is at least one selected from a group consisting prioritizing electronic communications associated with at least one of the plurality of communication groups based on the plurality of communication groups as ranked, grouping electronic communications associated with at least one of the plurality of communication groups based on the plurality of communication groups as ranked, and marking electronic communications associated with at least one of the plurality of communication groups based on the plurality of communication groups as ranked.

12. The system of claim 1, wherein the at least one automatic action includes of outputting a priority score of at least one of the plurality of communication groups and displaying information regarding electronic communications included in the at least one of the plurality of communication groups in response to selection of the priority score.

13. A method of automatically determining a priority of a user based on electronic activity of the user, the method comprising:
determining, with an electronic processor, a topic of each of a plurality of electronic communications associated with the user;
determining, with the electronic processor, a plurality of communication groups, wherein each communication group includes a subset of the plurality of electronic communications having a common topic;
determining, with the electronic processor, for each of the plurality of communication groups, a priority score of the common topic associated with the communication group for the user;
ranking, with the electronic processor, the plurality of communication groups based on the priority score of each of the plurality of communication groups; and
performing at least one automatic action for at least one of the plurality of communication groups based on the priority score of each of the plurality of communication groups as ranked.

14. The method of claim 13, wherein determining the priority score of the common topic associated with one of the plurality of communication groups includes determining a quantity of electronic communications included in the at least one of the plurality of communication groups.

15. The method of claim 13, wherein determining the priority score of the common topic associated with one of the plurality of communication groups includes determining a type of each electronic communication included in the at least one of the plurality of communication groups, and assign a weight to each electronic communication included in the at least one of the plurality of communication groups based on the type.

16. The method of claim 13, wherein determining the priority score of the common topic associated with one of the plurality of communication groups includes determining a weight for at least one electronic communication based on a parameter of the at least one electronic communication.

17. A non-transitory, computer-readable medium comprising instructions that, when executed by an electronic processor, perform a set of functions, the set of functions comprising:
determining a topic of each of a plurality of electronic communications associated with a group of users;
determining a plurality of communication groups, wherein each communication group includes a subset of the plurality of electronic communications having a common topic;
determining, for each of the plurality of communication groups, a priority score of the common topic associated with the communication group for the group of users;
ranking the plurality of communication groups based on the priority score of each of the plurality of communication groups; and
performing at least one automatic action for at least one of the plurality of communication groups based on the priority score of each of the plurality of communication groups as ranked.

18. The non-transitory, computer-readable medium of claim 17, wherein determining the priority score of the common topic associated with one of the plurality of communication groups includes determining a type of each electronic communication included in the at least one of the plurality of communication groups, and assign a weight to each electronic communication included in the at least one of the plurality of communication groups based on the type.

19. The non-transitory, computer-readable medium of claim 17, wherein determining the priority score of the common topic associated with one of the plurality of communication groups includes determining a weight for at least one electronic communication based on a parameter of the at least one electronic communication.

20. The non-transitory, computer-readable medium of claim 17, wherein performing the at least one automatic action includes generating a notification when the priority score of at least one of the plurality of communication groups fails to satisfy a threshold.
